(19) United States
(12) Patent Application Publication
(10) Pub. No.: US 2018/0254560 A1
(43) Pub. Date: Sep. 6, 2018

(54) ANTENNA DEVICE

(71) Applicant: FUJITSU LIMITED, Kawasaki-shi (JP)

(72) Inventors: Shohei Ishikawa, Yokohama (JP); Yoji Ohashi, Fucyu (JP)

(73) Assignee: FUJITSU LIMITED, Kawasaki-shi (JP)

(21) Appl. No.: 15/901,422

(22) Filed: Feb. 21, 2018

(30) Foreign Application Priority Data
Mar. 3, 2017 (JP) 2017-040680

(51) Int. Cl. H01Q 9/04; H01Q 1/38

(52) U.S. Cl. CPC H01Q 9/0435; H01Q 1/38; H01Q 9/0414

(57) ABSTRACT

An antenna device includes a ground layer, a first insulating layer, a second insulating layer layered on the ground layer and disposed under a first insulating layer, a patch antenna layered on the first insulating layer for emitting a circularly polarized radio wave, and a parasitic element provided between the first insulating layer and the second insulating layer. The patch antenna includes first and second feed points located in vicinity of a periphery of the patch antenna, which are respectively configured to receive high frequency electrical power having a 90-degree phase difference. The parasitic element is placed in a planar view so as to overlap with at least a part of the periphery of the patch antenna close to the first feed point and the second feed point.

### CROSS-REFERENCE TO RELATED APPLICATION

This application is based upon and claims the benefit of priority of the prior Japanese Patent Application No. 2017-040680, filed on Mar. 3, 2017, the entire contents of which are incorporated herein by reference.

### FIELD

The embodiments discussed herein relate to an antenna device.

### BACKGROUND

A microstrip antenna for a circularly polarized wave has been developed, which includes a dielectric plate, a metal substrate provided on one side of the dielectric plate, and a first metal plate provided on the other side of the dielectric plate. Also, for example, in a microstrip antenna for a circularly polarized wave that is disclosed in Patent Document 1, the first metal plate is oval, and at least one second oval metal plate is provided in the dielectric body. The microstrip antenna disclosed in Patent Document 1 is configured such that electrical power is fed from the metal substrate into either the first oval metal plate or one of the at least one second oval metal plate via the dielectric plate.

However, in the antenna device in Patent Document 1, the second oval metal plate is arranged concentrically with the first plate in a planar view. Thus, even if uneven distribution of a radio wave emitted from the first plate occurs, the uneven distribution cannot be adjusted. When such an uneven distribution occurs, emission characteristic of the antenna device is degraded.

The following is a reference document:
[Patent Document 1] Japanese Laid-Open Patent Publication No. 57-91003.

### SUMMARY

According to an aspect of the embodiments, an antenna device includes a ground layer, a first insulating layer, a second insulating layer layered on the ground layer and disposed under the first insulating layer, a rectangular or circular shaped patch antenna layered on the first insulating layer for emitting a circularly polarized radio wave, and a layered parasitic element provided between the first insulating layer and the second insulating layer.

The patch antenna includes a first feed point and a second feed point each located in vicinity of a periphery of the patch antenna. The first feed point is configured to receive first high frequency electrical power, and the second feed point is configured to receive second high frequency electrical power having a 90-degree phase difference from the first high frequency electrical power.

In a case where the patch antenna is rectangular, the parasitic element is placed in a planar view such that the parasitic element overlaps with a part or entirety of two edges of the patch antenna located close to the first feed point and the second feed point, and that the parasitic element straddles the part or entirety of two edges. In a case where the patch antenna is circular, the parasitic element is placed in a planar view such that the parasitic element overlaps with a part of an arc of the patch antenna close to the first feed point and the second feed point as seen from a center of the patch antenna, and that the parasitic element straddles the part of the arc.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is a diagram illustrating an antenna device according to an embodiment;

FIG. 2 is a cross-sectional view taken along a line A1-A2 in FIG. 1;

FIG. 3 is a cross-sectional view taken along a line A1-B in FIG. 1;

FIG. 4 is a diagram illustrating a distribution of current flowing on a patch antenna;

FIG. 5 is a diagram illustrating a distribution of current flowing on the patch antenna;

FIG. 6 is a graph illustrating frequency characteristics of an axial ratio of a circularly polarized wave emitted by the antenna device according to the embodiment;

FIG. 7 is a graph illustrating frequency characteristics of an axial ratio of a circularly polarized wave emitted by an antenna device for comparison;

FIG. 8 is a diagram illustrating an antenna device according to a modified example of the embodiment;

FIG. 9 is a diagram illustrating an antenna device according to another modified example of the embodiment; and

FIG. 10 is a diagram illustrating an antenna device according to yet another modified example of the embodiment.

### DESCRIPTION OF EMBODIMENT

Hereinafter, embodiments of the present disclosure will be described.

### Embodiment

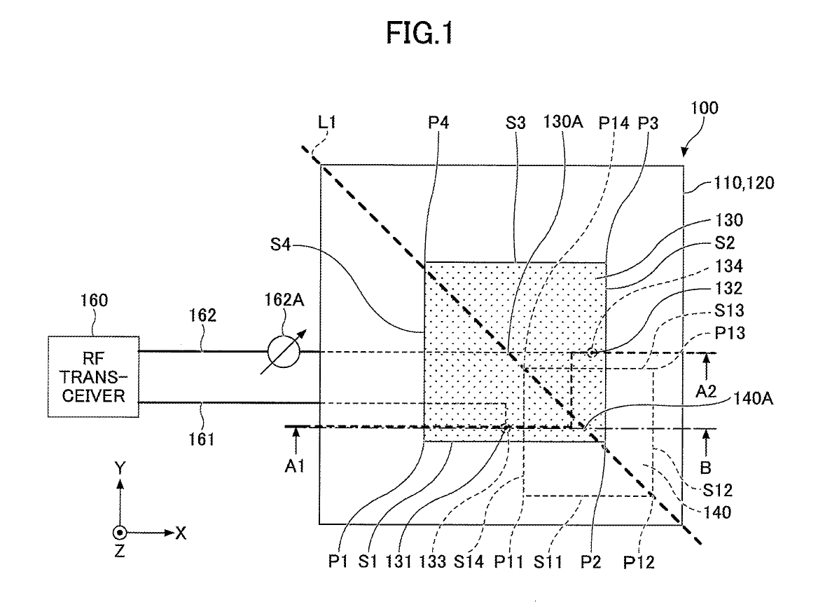

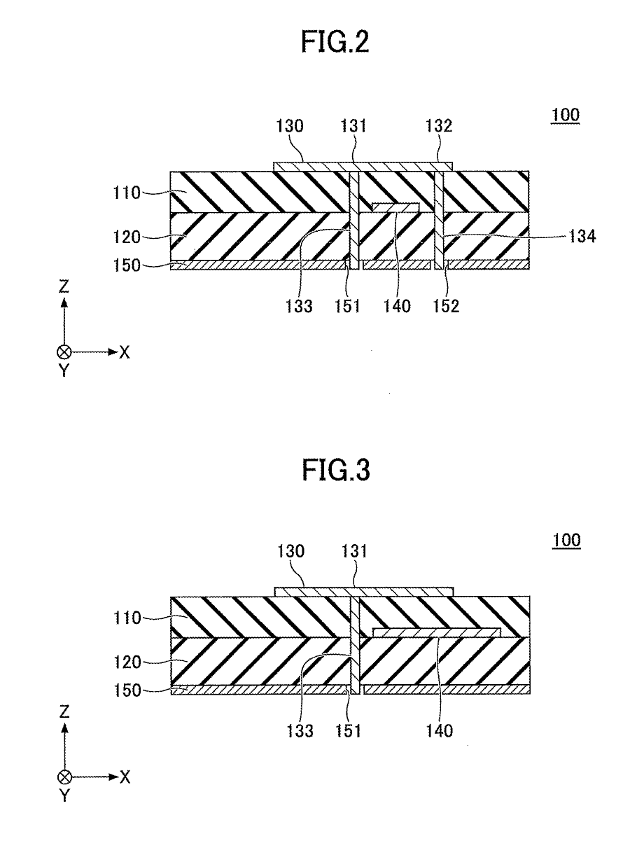

FIG. 1 is a diagram illustrating an antenna device 100 according to the present embodiment. FIG. 2 is a cross-sectional view taken along a line A1-A2 in FIG. 1. FIG. 3 is a cross-sectional view taken along a line A1-B in FIG. 1. In the following description, an XYZ coordinate system is used to describe directions of elements. Note that directions of an X-axis, a Y-axis, and a Z-axis are as illustrated in the drawings.

The antenna device 100 includes insulating layers 110 and 120, a patch antenna 130, a parasitic element 140, and a ground layer 150. The antenna device 100 is implemented by a circuit board containing two insulating layers (the insulating layers 110 and 120) and three metal layers (the patch antenna 130, the parasitic element 140, and the ground layer 150).

The circuit board is for example a build-up multi-layered circuit board in compliance with a FR-4 (Flame Retardant type 4) standard. The circuit board containing two insulating layers and three metal layers is manufactured by thermally curing the layers in a laminated state. Note that “multi-layered” means that a circuit board includes two or more insulating layers and three or more metal layers. In the present embodiment, a case is described in which a circuit board containing two insulating layers and three metal layers is used. But the circuit board may include more than two insulating layers or more than three metal layers.

Further, as illustrated in FIG. 1, an RF (Radio Frequency) transceiver 160 is connected to the antenna device 100. However, illustration of the RF transceiver 160 is omitted in FIG. 2 and FIG. 3.

The insulating layers 110 and 120 are a core layer or a pre-preg layer used as an insulating layer of a circuit board. Here, as an example, a case is described in which the insulating layer 110 is pre-preg layer and the insulating layer 120 is a core layer. The insulating layers 110 and 120 are respectively an example of a first insulating layer and a second insulating layer. However, the insulating layers 110 and 120 may not necessarily be a core layer or a pre-preg layer. Other materials, which can be used for an insulating layer of a circuit board, may be used as the insulating layers 110 and 120.

On a surface on the positive side of the Z-axis of the insulating layer 110, the patch antenna 130 is provided. Between the insulating layers 110 and 120, the parasitic element 140 is provided. Further, on a surface on the negative side of the Z-axis of the insulating layer 120, the ground layer 150 is provided. The surface on the positive side of the Z-axis of the insulating layer 110 is an example of a first surface, and the surface on the negative side of the Z-axis of the insulating layer 110 is an example of a second surface.

The patch antenna 130 is provided on the surface on the positive side of the Z-axis of the insulating layer 110, and is a square metal layer having edges S1, S2, S3, and S4, and vertices P1, P2, P3, and P4. The patch antenna 130 may be formed of copper foil, for example. The patch antenna 130 includes two feed points 131 and 132. The patch antenna 130 emits a circularly polarized radio wave to the Z-axis direction. Electrical length of each edge of the patch antenna 130 is, for example, a half of a wavelength λ of a communication frequency of the antenna device 100 (λ/2).

The feed points 131 and 132 are respectively provided in the vicinity of the midpoint of the edge S1 and the vicinity of the midpoint of the edge S2, which is adjacent to the edge S1. The feed points 131 and 132 are respectively an example of a first feed point and a second feed point. As current flows in a periphery of the patch antenna 130 (portion of the patch antenna 130 along the edges S1, S2, S3, and S4) more than in other portions, if the feed points 131 and 132 are provided near the edges S1 and S2, impedance of the feed points 131 and 132 becomes smaller.

Note that the vicinity of the midpoint of the edge S1 is a location where the midpoint of the edge S1 is offset to a direction of the edge S3 (opposite side of the edge S1). Similarly, the vicinity of the midpoint of the edge S2 is a location where the midpoint of the edge S2 is offset to a direction of the edge S4 (opposite side of the edge S2). The feed point 131 is located at the center of the width in the X-axis direction of the patch antenna 130, and the feed point 132 is located at the center of the width in the Y-axis direction of the patch antenna 130. It should be noted that an amount of the offset may be zero. When the offset is zero, the feed point 131 or 132 is located on the edge S1 or S2.

The feed points 131 and 132 are respectively connected to vias 133 and 134 which are formed in through-holes penetrating the insulating layers 110 and 120 in a thickness direction (Z-axis direction). One end of the vias 133 and 134, on the negative side of the Z-axis, is respectively exposed at openings 151 and 152 that are formed on the ground layer 150. The opening 151 and the end of the via 133 on the negative side of the Z-axis are electrically insulated from each other, and the opening 152 and the end of the via 134 on the negative side of the Z-axis are electrically insulated from each other.

The vias 133 and 134 are connected to the RF transceiver 160 via coaxial cables 161 and 162 respectively. In a middle segment of the coaxial cable 162, a 90-degree phase shifter 162A is inserted. High frequency electrical power that is output from the RF transceiver 160 is supplied to the feed point 131 via the coaxial cable 161 (and the via 133), and is also supplied to the feed point 132 via the coaxial cable 162 (and the via 134).

The high frequency electrical power supplied to the feed point 132 via the coaxial cable 162 lags behind the high frequency electrical power supplied to the feed point 131 via the coaxial cable 161 by 90 degrees, because the high frequency electrical power supplied to the feed point 132 via the coaxial cable 162 is delayed by the 90-degree phase shifter 162A by 90 degrees. Therefore, the patch antenna 130 emits a high frequency radio wave of a circularly polarized wave. Frequency of the high frequency radio wave emitted by the patch antenna 130 is, for example, 60 GHz, what is known as a millimeter wave.

The parasitic element 140 is a rectangular metal layer in a planar view, which is provided between the insulating layers 110 and 120. The size of the parasitic element 140 is, for example, smaller than the size of the patch antenna 130. The parasitic element 140 includes edges S11, S12, S13, and S14, and vertices P11, P12, P13, and P14. In the following description, let a line passing through a center 130A of the patch antenna 130 and the vertices P2 and P4 be L1. Further, let a center of the parasitic element 140 be 140A. The line L1 is an axis of symmetry between the feed points 131 and 132.

The center 140A of the parasitic element 140 is offset from the center 130A of the patch antenna 130 to a direction of the vertex P2 along the line L1. The vertices P12 and P14 are on the line L1.

The edge S11 of the parasitic element 140 is on the Y-axis negative side from the edge S1 of the patch antenna 130, the edge S12 is on the X-axis positive side from the edge S2, the edge S13 is on the Y-axis negative side from the feed point 132, and the edge S14 is on the X-axis positive side from the feed point 131.

Accordingly, the parasitic element 140 is placed such that it overlaps with a part of the edge S1 of the patch antenna 130 on the positive side of the X-axis from the feed point 131, and a part of the edge S2 on the negative side of the Y-axis from the feed point 132. Also, the parasitic element 140 is placed such that a part of the parasitic element 140 protrudes from the patch antenna 130 beyond the edges S1 and S2.

In other words, out of four squares made by dividing the patch antenna 130 with a line passing through the midpoints of the edges S1 and S3 and a line passing through the midpoints of the edges S2 and S4, a part of the square located on the X-axis positive side and the Y-axis negative side overlaps with the parasitic element 140. Also, the parasitic element 140 is placed such that a part of the parasitic element 140 protrudes from the patch antenna 130 beyond the edges S1 and S2.

In other words still, the parasitic element 140 is placed such that the parasitic element 140 overlaps with a region in the patch antenna 130 interposed between the two feed points 131 and 132 and that a part of the parasitic element 140 protrudes from the patch antenna 130 beyond the edges S1 and S2.

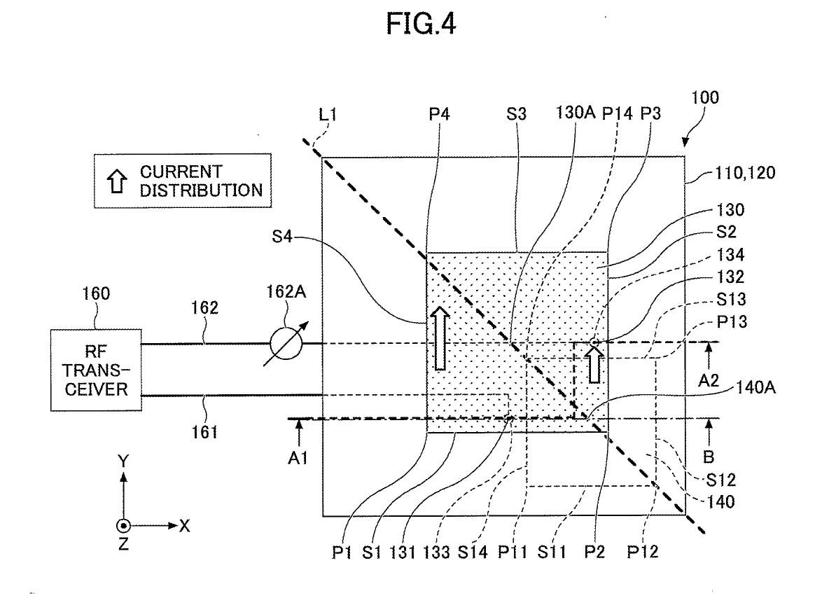

As described above, the parasitic element 140 is placed so as to overlap with parts of the edges S1 and S2 of the patch antenna 130 in a planar view and to straddle parts of the edges S1 and S2. If the state of the parasitic element 140 overlapping with parts of the edges S1 and S2 of the patch antenna 130 in a planar view and of the parasitic element 140 straddling parts of the edges S1 and S2 is expressed in other words, it can be said that the parasitic element 140 overlaps with parts of the edges S1 and S2 in a planar view and that the parasitic element 140 exists on both the inner and outer sides of the parts of the edges S1 and S2 continuously. The reason that the parasitic element 140 is arranged as described above will be described below with reference to FIGS. 4 to 7.

As a reflective layer for reflecting a radio wave emitted from the patch antenna 130 to the negative direction of the Z-axis, back to the positive direction of the Z-axis, the ground layer 150 is provided on the surface on the negative side of the Z-axis of the insulating layer 120. The ground layer 150 is provided to improve efficiency of reflection of the patch antenna 130.

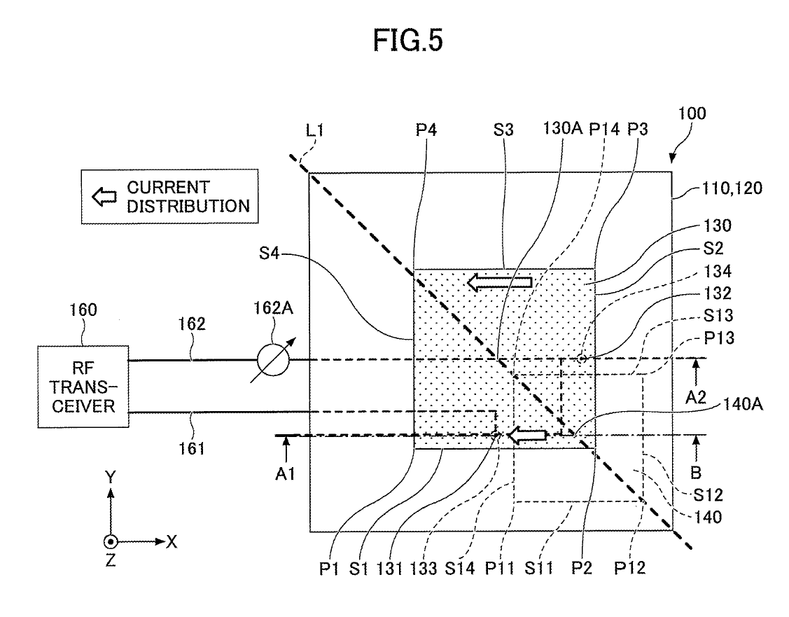

FIGS. 4 and 5 are diagrams illustrating distributions of current flowing on the patch antenna 130. Arrows illustrated in FIG. 4 express a direction of current. In FIG. 4, length of the arrow illustrated in the drawings is proportional to an amount of current. That is, in an area of the patch antenna 130 where the longer arrow is drawn, more current flows as compared to an area where the shorter arrow is drawn.

In the patch antenna 130, an amount of current flowing close to the edges S1, S2, S3, and S4 is larger than an amount of current flowing near the center 130A.

As illustrated in FIG. 4, at a certain point of time (for example, at time t=0), by the high frequency electrical power supplied to the feed point 131, current flows along the edges S2 and S4 of the patch antenna 130 to the positive direction of the Y-axis. At the edge S2, as current flowing close to the edge S2 is disturbed by the feed point 132 provided near the edge S2, an amount of current flowing along the edge S2 is smaller than an amount of current flowing along the edge S4. Therefore in FIG. 4, the arrow illustrated along the edge S2 is shorter than the arrow along the edge S4.

At a time when a quarter cycle of the high frequency electrical power has elapsed from time t=0, by the high frequency electrical power supplied to the feed point 132, current flows along the edges S1 and S3 of the patch antenna 130 to the negative direction of the X-axis. On the side of the edge S1, as flow of current is disturbed by the feed point 131 provided near the edge S1, an amount of current flowing along the edge S1 is smaller than an amount of current flowing along the edge S3. Therefore in FIG. 5, the arrow illustrated along the edge S1 is shorter than the arrow along the edge S3.

As a phase difference between the high frequency electrical power supplied to the feed point 131 and the high frequency electrical power supplied to the feed point 132 is π/2, and each of the high frequency electrical power becomes maximum or minimum alternately with a phase difference of π/2, direction of current flowing on the patch antenna 130 changes in the following order: the positive direction of the Y-axis, the negative direction of the X-axis, the negative direction of the Y-axis, and the positive direction of the X-axis. Therefore, a circularly polarized radio wave is emitted from the patch antenna 130 to the Z-direction.

As an amount of current flowing on the side of the edge S3 is larger than an amount of current flowing on the side of the edge S1 in the patch antenna 130, and an amount of current flowing on the side of the edge S4 is larger than an amount of current flowing on the side of the edge S2 in the patch antenna 130, strength of the radio wave emitted from the patch antenna 130 becomes stronger on the side closer to the vertex P4 (with respect to the center 130A), and becomes weaker on the side closer to the vertex P2 (with respect to the center 130A), in a case in which the parasitic element 140 is not present. That is, uneven distribution of the radio wave strength occurs.

When the parasitic element 140 is arranged as illustrated in FIG. 1, capacitance is generated between the patch antenna 130 and the parasitic element 140. Accordingly, capacitance of the patch antenna 130 increases on the side of the vertex P2, and an amount of radio wave emission increases in a region where the patch antenna 130 and the parasitic element 140 are overlapped.

That is, by arranging the parasitic element 140 as illustrated in FIG. 1, uneven distribution of the circularly polarized radio wave emitted by the patch antenna 130, in which the radio wave on the side of the vertex P4 is stronger than that on the side of the vertex P2, is corrected, and strength of the radio wave is equalized on each of the vertices P1, P2, P3, and P4.

Because of the reason, the parasitic element 140 is placed as described above to equalize the distribution of the radio wave strength.

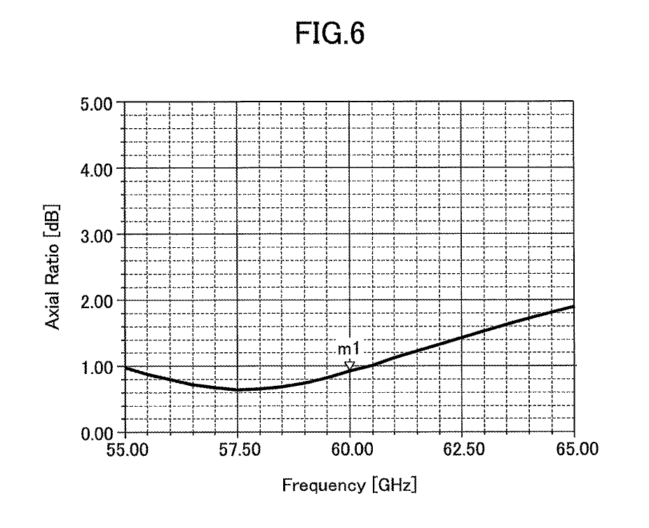

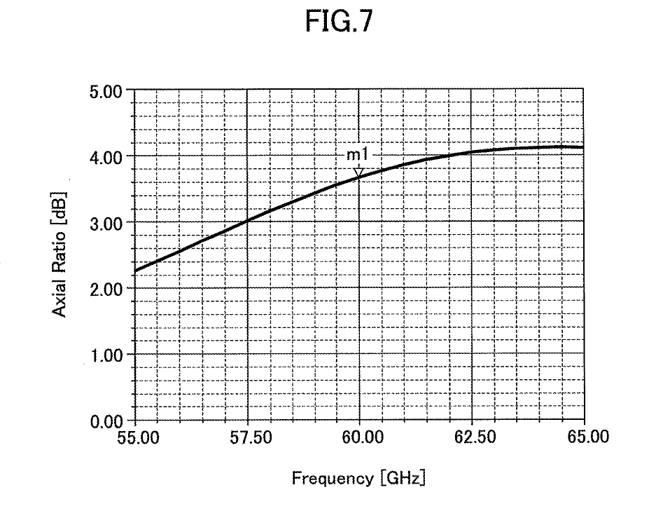

FIGS. 6 and 7 are graphs illustrating frequency characteristics of an axial ratio of the circularly polarized wave. The frequency characteristics illustrated in FIGS. 6 and 7 are obtained through simulation. FIG. 6 illustrates the frequency characteristics of the axial ratio of the circularly polarized wave emitted by the patch antenna 130 of the antenna device 100 including the parasitic element 140. In FIG. 7, for comparison, the frequency characteristics of the axial ratio of the circularly polarized wave emitted by a patch antenna of an antenna device not including the parasitic element 140 is illustrated. Note that a frequency of high frequency electrical power fed into the patch antenna 130 is 60 GHz.

In FIG. 6, the axial ratio at a frequency of 60 GHz is approximately 0.9 dB. In FIG. 7, the axial ratio at a frequency of 60 GHz is approximately 3.6 dB. The smaller the axial ratio is, the closer to a true circle the obtained circularly polarized wave is.

Accordingly, it is understood that a shape of the circularly polarized wave is corrected to be close to a true circle, by providing the parasitic element 140. This is because the distribution of the circularly polarized radio wave emitted by the patch antenna 130 is equalized by providing the parasitic element 140.

As described above, according to the present embodiment, the distribution of the circularly polarized radio wave emitted by the patch antenna 130 can be equalized by placing the parasitic element 140 such that the parasitic element 140 overlaps with a part of the edge S1 of the patch antenna 130 on the X-axis positive side from the feed point 131, and a part of the edge S2 on the Y-axis negative side from the feed point 132, and that a part of the parasitic element 140 protrudes from the patch antenna 130 beyond the edges S1 and S2.

The reason the distribution of the circularly polarized radio wave is equalized is, the parasitic element 140 is provided such that the parasitic element 140 overlaps, in a planar view, with the edges S1 and S2 of the patch antenna 130 where less current flows than in the other edges, and that the parasitic element 140 straddles the edges S1 and S2. Regarding strength of the radio wave emitted from the patch antenna 130, current flowing along the edges S1 to S4 is dominant factor. However, as the feed points 131 and 132 are respectively provided in the vicinity of the edges S1 and S2, the current flowing along the edges S1 and S2 becomes less than the current flowing along the edges S3 and S4. Hence, an amount of radio wave emission from the edges S1 and S2 becomes less than an amount of radio wave emission from the edges S3 and S4.

To avoid such a problem, by placing the parasitic element 140 such that the parasitic element 140 overlaps with a part of the edges S1 and S2 of the patch antenna 130 in a planar view, and that the parasitic element 140 straddles the part of the edges S1 and S2, capacitance of part of the edges S1 and S2 overlapping with the parasitic element 140 is increased.

When the capacitance of the part along the edges S1 and S2 increases, the current flowing along the edges S1 and S2 increases. Accordingly, the distribution of the circularly polarized radio wave emitted by the patch antenna 130 can be equalized.

Therefore according to the present embodiment, the antenna device 100 having improved emission characteristics can be provided.

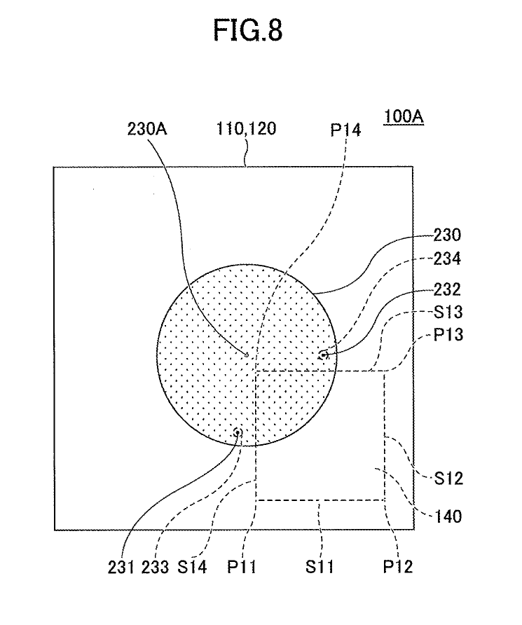

FIG. 8 is a diagram illustrating an antenna device 100A according to a modified example of the above embodiment. The antenna device 100A is made by replacing the rectangular patch antenna 130 illustrated in FIG. 1 with a circular patch antenna 230. The patch antenna 230 includes feed points 231 and 232, each of which is provided at similar locations to the feed points 131 and 132 of the patch antenna 130. The feed points 231 and 232 are respectively connected to vias 233 and 234.

With respect to the antenna device 100A, similar to the antenna device 100, the parasitic element 140 is placed such that it overlaps with a part of the patch antenna 230 on the X-axis positive side from the feed point 231 and on the Y-axis negative side from the feed point 232. Also, the parasitic element 140 is placed such that a part of the parasitic element 140 protrudes from the patch antenna 230.

In other words, the parasitic element 140 is placed such that the parasitic element 140 overlaps in plan view with a part of the patch antenna 230 located with respect to the feed points 231 and 232 rather than a center 230A of the patch antenna 230. Also, the parasitic element 140 is placed such that a part of the parasitic element 140 protrudes from the patch antenna 230.

In other words still, the parasitic element 140 is placed such that it overlaps with a region in the patch antenna 230 interposed between the two feed points 231 and 232 and that a part of the parasitic element 140 protrudes from the patch antenna 230.

Accordingly, by placing the parasitic element 140 such that the parasitic element 140 overlaps in plan view with a part of the circumference (arc) of the circular patch antenna 230 on a side close to the feed points 231 and 232, and that the parasitic element 140 straddles the part of the circumference (arc) on the side close to the feed points 231 and 232, capacitance of a part in the vicinity of the arc overlapping in plan view with the parasitic element 140 is increased.

If the capacitance of the arc part of the patch antenna 230 close to the feed points 231 and 232 is increased, current flowing on the arc part will be increased. Accordingly, the distribution of the circularly polarized radio wave emitted by the patch antenna 230 can be equalized. Note that the arc close to the feed points 231 and 232 is an arc close to both the feed points 231 and 232, as seen from the center 230A. More specifically, the arc close to the feed points 231 and 232 is an arc of a sector enclosed by a radius which passes through the feed point 231 from the center 230A, a radius which passes through the feed point 232 from the center 230A, and an- arc of the patch antenna 230 between the two radii as seen from the center 230A.

Therefore, the antenna device 100A having improved emission characteristics can be provided.

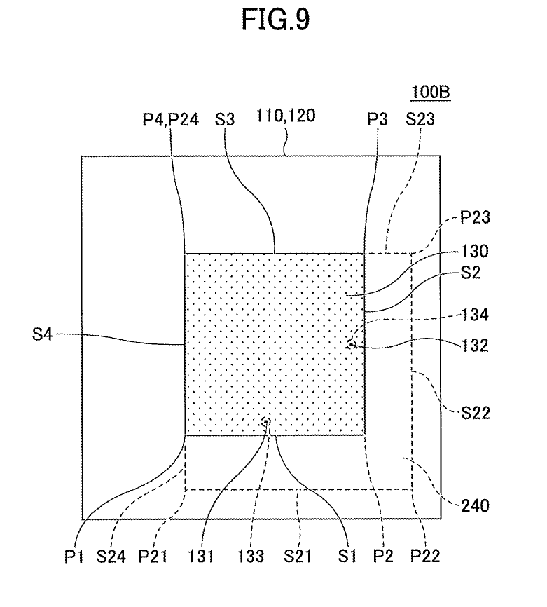

FIG. 9 is a diagram illustrating an antenna device 100B according to another modified example of the above embodiment. The antenna device 100B is made by replacing the rectangular parasitic element 140 illustrated in FIG. 1 with a parasitic element 240 larger than the parasitic element 140.

The parasitic element 240 is a rectangular metal layer including edges S21, S22, S23, and S24, and vertices P21, P22, P23, and P24. The parasitic element 240 is placed such that the edges S21, S22, S23, and S24 and the vertices P21, P22, P23, and P24 are located according to the following. The vertex P24 of the parasitic element 240 is located at the same location as the vertex P4 of the patch antenna 130. The edge S21 is located to the Y-axis negative side from the edge S1 of the patch antenna 130. The edge S22 is located to the X-axis positive side from the edge S2 of the patch antenna 130. Further, the edges S23 and S24 respectively coincide with the edges S3 and S4 of the patch antenna 130, and a part of the edge S23 on the X-axis positive side and a part of the edge S24 on the Y-axis negative side protrude from the patch antenna 130.

In the antenna device 100B, the entire patch antenna 130 is overlapped with the parasitic element 240, and the parasitic element 240 is placed such that the parasitic element 240 protrudes from the patch antenna 130 beyond the edges S1 and S2. That is, the entirety of the edges S1 and S2 of the patch antenna 130 overlap with the parasitic element 240 in a planar view, and the parasitic element 240 is placed so as to straddle the entirety of the edges S1 and S2.

Because of this configuration, capacitance of the part along the edges S1 and S2 of the patch antenna 130 can increase, and current flowing along the edges S1 and S2 increases. Accordingly, a distribution of a circularly polarized radio wave emitted by the patch antenna 130 can be equalized.

Therefore, the antenna device 100B having improved emission characteristics can be provided.

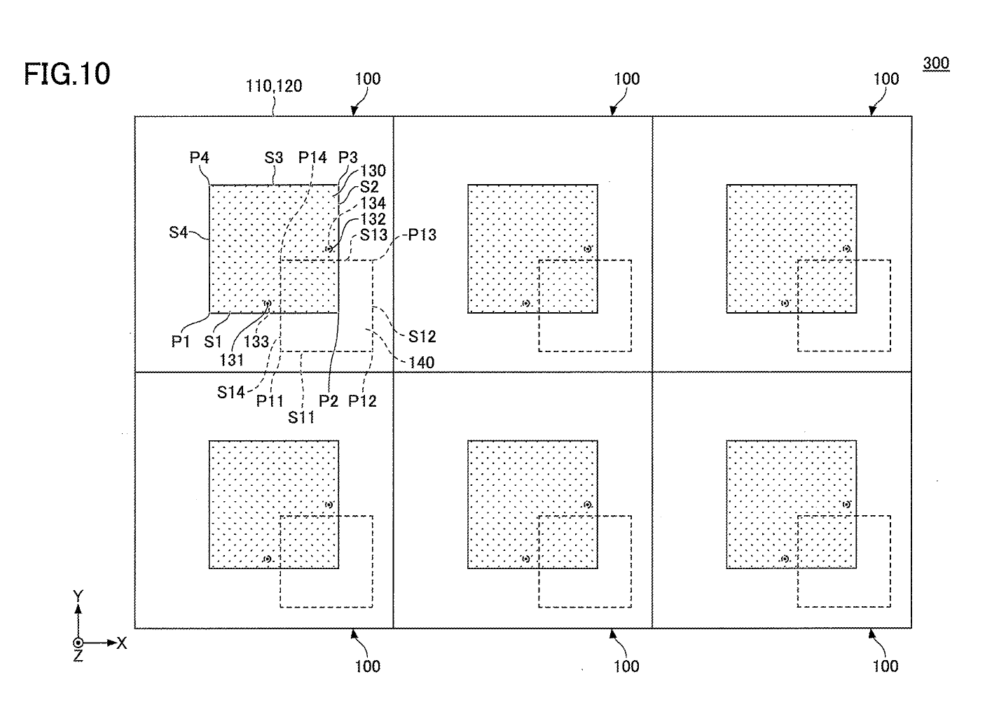

FIG. 10 is a diagram illustrating an antenna device 300 according to yet another modified example of the above embodiment. The antenna device 300 includes the six antenna devices 100 arranged in a matrix state of 2 rows and 3 columns. The six antenna devices 100 in the antenna device 300 can be manufactured at a same time by using a circuit board.

For instance, by applying phase differences to millimeter waves emitted from the six antenna devices 100, an elevation angle and an azimuth of a beam formed by superposing the millimeter waves emitted from the six antenna devices 100 can be controlled. In the above description, the antenna device 300 including the six antenna devices 100 arranged in a matrix state of 2 rows and 3 columns was described, but any number of the antenna devices 100 may be included in the antenna device 300, as long as the antenna device 300 includes more than one antenna device 100.

All examples and conditional language provided herein are intended for pedagogical purposes of aiding the reader in understanding the invention and the concepts contributed by the inventors to further the art, and are not to be construed as limitation to such specifically recited examples and conditions, nor does the organization of such examples in the specification relate to a showing of superiority and inferiority of the invention. Although one or more embodiments of the present invention have been described in detail, it should be understood that various changes, substitutions, and alterations could be made hereto without departing from the spirit and scope of the invention.

What is claimed is:

1. An antenna device comprising:
a ground layer;
a first insulating layer;
a second insulating layer layered on the ground layer and disposed under the first insulating layer;
a rectangular or circular shaped patch antenna layered on the first insulating layer for emitting a circularly polarized radio wave, the patch antenna including a first feed point and a second feed point each located in vicinity of a periphery of the patch antenna, the first feed point being configured to receive first high frequency electrical power, and the second feed point being configured to receive second high frequency electrical power having a 90-degree phase difference from the first high frequency electrical power; and
a layered parasitic element provided between the first insulating layer and the second insulating layer, the parasitic element being placed in a planar view such that
a) for the rectangular shaped patch antenna, the parasitic element overlaps with a part or entirety of two edges of the patch antenna located close to the first feed point and the second feed point, and the parasitic element straddles the part or entirety of two edges, or
b) for the circular shaped patch antenna, the parasitic element overlaps with a part of an arc of the patch antenna close to the first feed point and the second feed point as seen from a center of the patch antenna, and the parasitic element straddles the part of the arc.

2. The antenna device according to claim 1,
the first insulating layer including two of first through-holes penetrating the first insulating layer in a thickness direction, the first through-holes respectively coinciding with the first feed point and the second feed point in the planar view;
the second insulating layer including two of second through-holes penetrating the second insulating layer in the thickness direction, the second through-holes respectively coinciding with the first feed point and the second feed point in the planar view, and further respectively being connected to the two first through-holes;
the ground layer including two openings respectively coinciding with the first feed point and the second feed point in the planar view, and respectively connected to the two second through-holes; wherein
the antenna device further includes two vias respectively inserted inside the two openings, the two second through-holes, and the two first through-holes, the vias being insulated from the ground layer and the parasitic element; and
the patch antenna is configured to receive the first high frequency electrical power and the second high frequency electrical power via the two vias.

3. The antenna device according to claim 1,
wherein the antenna device is formed of a circuit board including a first metal layer, a second metal layer, a third metal layer, and two insulating layers interposed between the first metal layer and the third metal layer; and
the first metal layer, the second metal layer, and the third metal layer are provided as the patch antenna, the parasitic element, and the ground layer.
